(19) United States
(12) Patent Application Publication
(10) Pub. No.: US 2020/0380899 A1
(43) Pub. Date: Dec. 3, 2020

(54) METHOD AND APPARATUS FOR DETECTING PERIPHERAL CIRCUIT OF DISPLAY SCREEN, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Yawei WEN, Beijing (CN); Jiabing LENG, Beijing (CN); Minghao LIU, Beijing (CN); Yulin XU, Beijing (CN); Jiangliang GUO, Beijing (CN); Xu LI, Beijing (CN)

(21) Appl. No.: 16/995,898

(22) Filed: Aug. 18, 2020

Related U.S. Application Data
(63) Continuation of application No. PCT/CN2019/085912, filed on May 8, 2019.

(30) Foreign Application Priority Data
Jul. 2, 2018 (CN) 201810709836.7

(51) Int. Cl. G09G 3/00; G01N 21/956; G06N 3/02; G06T 7/00

(52) U.S. Cl. CPC G09G 3/006; G01N 21/95607; G06T 2207/30121; G06T 7/0008; G06T 2207/20084; G06N 3/02

(57) ABSTRACT

The method and apparatus for detecting a peripheral circuit of a display screen provided by the present disclosure receive a quality detection request sent by a console deployed on a production line of the peripheral circuit of the display screen, where the quality detection request includes a peripheral circuit image of the display screen captured by an image capturing device on the production line of the peripheral circuit of the display screen; zoom in or out on the peripheral circuit image of the display screen to obtain an image to be detected a size of which is consistent with an input size requirement of a defect detection model; input the image to be detected into the defect detection model to obtain a defect detection result; and determine quality of the peripheral circuit of the display screen according to the defect detection result.

### CROSS-REFERENCE TO RELATED DISCLOSURES

This application is a continuation of International Application No. PCT/CN2019/085912, filed on May 8, 2019, which claims priority to Chinese Patent Application No. 201810709836.7, filed with the Chinese Patent Office on Jul. 2, 2018 and titled “METHOD AND APPARATUS FOR DETECTING PERIPHERAL CIRCUIT OF DISPLAY SCREEN, ELECTRONIC DEVICE AND STORAGE MEDIUM”, the content of the aforementioned applications is incorporate herein by reference in their entireties.

### TECHNICAL FIELD

The present disclosure relates to defect detection technology and, in particular, to a method and an apparatus for detecting a peripheral circuit of a display screen, an electronic device and a storage medium.

### BACKGROUND

With the development of science and technology, the role of information display technology is increasing in people's life, and display screens are widely used due to the characteristics, such as small size, light weight, low power, high resolution, high brightness, no geometric deformation and so on. However, in the production process of the display screens, there may be defects, such as point defects, foreign matter defects, scratch defects, in a peripheral circuit of a display screen due to process and environmental reasons. Therefore, detection of the peripheral circuit of the display screen is an important part of the production process.

In the prior art, the detection of the peripheral circuit of the display screen mainly adopts a manual detection or a machine-assisted manual detection method. Specifically, the manual detection method refers to: an industry expert visually observes images captured from production environment and give judgment; the machine-assisted manual detection method refers to: firstly, a quality detection system, which is solidified with experience of industry experts, is used to detect the images of the periphery circuit of the display screen and select images suspected of being defective preliminary, and then the industry expert performs manual detection and judgment on the images suspected of being defective.

However, both the manual detection method and the machine-assisted manual detection method are influenced greatly by subjective human factors, which have low detection accuracy, poor system performance and low business expansion capability.

### SUMMARY

The present disclosure provides a method and an apparatus for detecting a peripheral circuit of a display screen, an electronic device and a storage medium, so as to overcome the problem of low detection accuracy, poor system performance and low business expansion capability due to the large influences by subjective human factors on the existing detection methods for the peripheral circuit of the display screen.

According to a first aspect of the present disclosure, a method for detecting a peripheral circuit of a display screen is provided, which includes:
receiving a quality detection request sent by a console deployed on a production line of the peripheral circuit of the display screen, where the quality detection request includes a peripheral circuit image of the display screen captured by an image capturing device on the production line of the peripheral circuit of the display screen;
zooming in or out on the peripheral circuit image of the display screen to obtain an image to be detected a size of which is consistent with an input size requirement of a defect detection model, where the detection model is obtained by performing training with a historical defective peripheral circuit image of the display screen using an instance segmentation Mask Regional Convolutional Neural Network algorithm;
inputting the image to be detected into the defect detection model to obtain a defect detection result; and
determining quality of the peripheral circuit of the display screen corresponding to the peripheral circuit image of the display screen according to the defect detection result.

Optionally, in a possible implementation of the first aspect, before inputting the peripheral circuit image of the display screen into the defect detection model to obtain the defect detection result, the method further includes:
performing training on the defect detection model with an actual pixel type of the historical defective peripheral circuit image of the display screen using the instance segmentation Mask RCNN algorithm, so that a loss value between a predicted pixel type that is outputted by the defect detection model for the historical defective peripheral circuit image of the display screen and the actual pixel type is lower than a preset loss threshold.

Optionally, in another possible implementation of the first aspect, before zooming in or out on the peripheral circuit image of the display screen, the method further includes:
performing image preprocessing on the peripheral circuit image of the display screen, where the image preprocessing includes one or more of the following processes:
trimming, cutting, or rotating.

Optionally, in a further possible implementation of the first aspect, inputting the image to be detected into the defect detection model to obtain the defect detection result, includes:
determining a detection model server that hosts a processing resource according to a load balancing policy;
inputting the image to be detected into the defect detection model that runs on the detection model server to obtain the defect detection result.

Optionally, in a further possible implementation of the first aspect, the defect detection result includes: a type of each defect, and/or a contour position of each defect;
determining quality of the peripheral circuit of the display screen corresponding to the peripheral circuit image of the display screen according to the defect detection result, includes:
determining the quality of the peripheral circuit of the display screen corresponding to the peripheral circuit image of the display screen according to production stage information and the defect detection result.

Optionally, in another possible implementation of the first aspect, after determining the quality of the display peripheral circuit corresponding to the peripheral circuit image of the display screen according to the defect detection result, the method further includes:
if it is determined that the peripheral circuit of the display screen is a damaged circuit, performing one or more of the following operations:
sending alarm information to a production manager through a controller;
storing the defect detection result as a log into a production database through the controller;
sending a production control instruction to the console through the controller to eliminate a defect;
inputting the peripheral circuit image of the display screen and the defect detection result to the defect detection model to optimize the defect detection model.

A second aspect of the present disclosure provides an apparatus for detecting a peripheral circuit of a display screen, including:
a receiving module, configured to receive a quality detection request sent by a console deployed on a production line of the peripheral circuit of the display screen, where the quality detection request includes a peripheral circuit image of the display screen captured by an image capturing device on the production line of the peripheral circuit of the display screen;
a preprocessing module, configured to zoom in or out on the peripheral circuit image of the display screen to obtain an image to be detected a size of which is consistent with an input size requirement of a defect detection model, where the defect detection model is obtained by performing training with a historical defective peripheral circuit image of the display screen using an instance segmentation Mask RCNN algorithm;
a processing module, configured to input the image to be detected into the defect detection model to obtain a defect detection result; and
a determining module, configured to determine quality of the peripheral circuit of the display screen corresponding to the peripheral circuit image of the display screen according to the defect detection result.

Optionally, in a possible implementation of the second aspect, the processing module is further configured to perform training on the defect detection model with an actual pixel type of the historical defective peripheral circuit image of the display screen using the instance segmentation Mask RCNN algorithm before inputting the image to be detected into the defect detection model to obtain the defect detection result, so that a loss value between a predicted pixel type that is outputted by the defect detection model for the historical defective peripheral circuit image of the display screen and an actual pixel type is lower than a preset loss threshold.

Optionally, in another possible implementation of the second aspect, the preprocessing module is further configured to perform image preprocessing on the peripheral circuit image of the display screen before zooming in or out on the peripheral circuit image of the display screen, where the image preprocessing includes one or more of the following processes: trimming, cutting, or rotating.

Optionally, in a further possible implementation of the second aspect, the processing module is specifically configured to determine a detection model server that hosts a processing resource according to a load balancing policy; and input the image to be detected into the defect detection model that runs on the defect detection server to obtain the defect detection result.

Optionally, in a further possible implementation of the second aspect, the defect detection result includes: a type of each defect, and/or a contour position of each defect; and
the determining module is specifically configured to determine the quality of the peripheral circuit of the display screen corresponding to the peripheral circuit image of the display screen according to production stage information and the defect detection result.

Optionally, in a further possible implementation of the second aspect, the processing module is further configured to perform one or more of the following operations if it is determined that the peripheral circuit of the display screen is a damaged circuit, after determining the quality of the peripheral circuit of the display screen corresponding to the peripheral circuit image of the display screen according to the defect detection result,
sending alarm information to a production manager through a controller;
restoring the defect detection result as a log into a production database through the controller;
sending a production control instruction to the console through the controller to eliminate a defect;
inputting the peripheral circuit image of the display screen and the defect detection result to the defect detection model to optimize the defect detection model.

A third aspect of the present disclosure provides an electronic device, including a processor, a memory, and a computer program stored on the memory and executable on the processor, and the processor implements the method according to any one of the first aspect and various possible implementations of the first aspect when executing the program.

A fourth aspect of the present disclosure provides a storage medium storing instructions which, when running on a computer, cause the computer to execute the method according to any one of the first aspect and various possible implementations of the first aspect.

The method and apparatus for detecting a peripheral circuit of a display screen, the electronic device and the storage medium provided by the present disclosure receive a quality detecting request sent by a console deployed on a production line of the peripheral circuit of the display screen, where the quality detecting request includes a peripheral circuit image of the display screen captured by an image capturing device on the production line of the peripheral circuit of the display screen; zoom in or out on the peripheral circuit image of the display screen to obtain an image to be detected a size of which is consistent with an input size requirement of a defect detection model, where the defect detection model is obtained by performing training with a historical defective peripheral circuit image of the display screen using an instance segmentation algorithm and a Mask RCNN; inputting the image to be detected into the defect detection model to obtain a defect detection result; and determine quality of the peripheral circuit image of the display screen corresponding to the peripheral circuit image of the display screen according to the defect detection result. Since the defect detection model is obtained by performing MASK RCNN training with the historical defective peripheral circuit image of the display screen, the defect detection result obtained with the defect detection model thus has high classification precision, strong intelligence capability, improved system performance and high business expansion capability, which can resolve the problem of low detection accuracy, poor system performance and low business expansion capability in existing defect detection methods for the peripheral circuit of the display screen caused by large influences of subjective human factors.

### BRIEF DESCRIPTION OF DRAWINGS

FIG. 1 is a schematic structural diagram of a system for detecting a peripheral circuit of a display screen provided by an embodiment of the present disclosure;

FIG. 2 is a schematic flowchart of Embodiment 1 of a method for detecting a peripheral circuit of a display screen provided by an embodiment of the present disclosure;

FIG. 3 is a schematic flowchart of Embodiment 2 of the method for detecting a peripheral circuit of a display screen provided by an embodiment of the present disclosure;

FIG. 4 is a schematic structural diagram of an embodiment of an apparatus for detecting a peripheral circuit of a display screen provided by an embodiment of the present disclosure; and

FIG. 5 is a schematic structural diagram of an embodiment of an electronic device provided by an embodiment of the present disclosure.

### DESCRIPTION OF EMBODIMENTS

The technical solutions in the embodiments of the present disclosure will be clearly and completely described in conjunction with the drawings in the embodiments of the present disclosure. Obviously, the embodiments described are only a part of the embodiments of the present disclosure but not all of the embodiments. All other embodiments obtained by those skilled in the art based on the embodiments of the present disclosure without creative efforts are within the scope of the present disclosure.

It should be understood that, in various embodiments of the present disclosure, the value of the sequence number of each process does not mean the order of execution and should not be taken as any limitation to the embodiments of the present disclosure, and the order of execution of each process should be determined by its function and internal logic.

It should be understood that in the present disclosure, “include” and “comprise” and any variations thereof are intended to cover a non-exclusive inclusion, for example, a process, method, system, product, or device that includes a series of steps or units is not necessarily limited to those steps or units listed clearly, but may include other steps or units that are not explicitly listed or inherent to such processes, methods, products, or devices.

It should be understood that in the present disclosure, “a plurality” means two or more. “And/or” is merely an association relationship describing associated objects, indicating that there may be three relationships, for example, A and/or B, may indicate that A exists separately, A and B exist simultaneously, and B exists separately. The character “/” generally indicates that the contextual objects are in an “or” relationship.

It should be understood that in the present disclosure, “B corresponding to A”, “A corresponds to B” or “B corresponds to A” means that B is associated with A, and B can be determined according to A. Determining B according to A does not mean that B is determined only based on A, but instead, B can also be determined based on A and/or other information. The match between A and B is that the similarity between A and B is greater than or equal to a preset threshold.

Depending on the context, “if” as used herein may be interpreted as “when” or “as” or “in response to determining” or “in response to detecting”.

Currently, the 3C industry (3C industry refers to the information appliance industry that integrates the disclosure of computer, communication, and consumer electronics) has a low overall intelligent automation degree, and the research and analysis on the industry of peripheral circuits for display screens, such as mobile phone screens, shows that detection methods used on mobile phone screens by most manufacturers can be divided into two types, namely: the manual detection method and the machine-assisted manual detection method.

Among them, the manual detection method refers to: an industry expert visually observes images captured from production environment and give judgment, and this method is influenced greatly by subjective human factors and has low detection efficiency and large damage to human eyes. Besides, since a production workshop of the peripheral circuit of the display screen is generally dust-free environment, a staff needs to prepare for cleaning and wear dust-free clothes before going in, which may also have adversely effect on health and safety of the staff.

The machine-assisted manual detection method can also be called as a detection method based on a liquid crystal module detection device, and the specific principle is: firstly, a quality detection system with certain judgment ability filters out the images without defects, and then an industry expert performs detection and judgment on the images suspected of being defective. In the machine-assisted manual detection method, the quality detection system is mostly developed from an expert system and a characteristic engineering system, which means that the quality detection system is solidified with expert experience to make it have certain automation capabilities. Therefore, the machine-assisted manual detection method not only has low accuracy and poor system performance, and cannot cover all the testing standards of manufacturers, this method but also has low efficiency and is easy to miss and misjudge defects, however, detected image data is difficult to be used for a secondary use and mining In addition, in the above quality detection system, the characteristics and judgment rules are solidified into the machine based on experiences of the industry experts, which is difficult to iterate with the development of the business, resulting in that with the development of the manufacturing technique, the detection accuracy of the quality inspection system becomes lower and lower, and may even be reduced to a state of being completely unusable. In addition, the characteristics of the quality detection system are solidified into hardware by a third-party supplier, and when upgrading, the production line needs to be transformed substantially, and in addition, the cost is very high, and it has obvious deficiencies in terms of safety, standardization and expansion capability, which is not conducive to the optimization and upgrading of the production line of the peripheral circuit of the display screen, and the business expansion capability is low.

In summary, both the manual detection method and the machine-assisted manual detection method have the following disadvantages: not only are they inefficient, but also prone to misjudgment, and industrial data generated by the two methods is difficulty to store, manage, and re-mine and reuse.

The embodiments of the present disclosure develop an automatic, high-precision, adaptive correction and upgrade method for detecting a peripheral circuit of a display screen based on the latest development of artificial intelligence technology in computer vision, which may use the peripheral circuit image of the display screen captured on the production line of the peripheral circuit of the display screen with an image capturing device, perform the detection and judgment on surface quality of the peripheral circuit image of the display screen. If it is detected that there is a defect on the peripheral circuit of the display screen captured by the current image capturing device, the position of each defect in the image and the type of each defect are determined. An embodiment of the present disclosure distinguishes defective individuals from the same type of defects.

Optionally, the defects described in the embodiments of the present disclosure may include, but are not limited to different types of defect problems, such as a type of point defect, a type of foreign object defect, a type of scratch defect, which will not be introduced one by one here.

It should be understood that in the present disclosure, the instance segmentation Mask RCNN algorithm is a two-stage framework, where in the first stage, an image is scanned to generate proposals (i.e. areas that may contain a target), and in the second stage the proposals are classified to generate bounding box(es) and mask(s). Mask R-CNN is an extension over Faster R-CNN, both of which were proposed by the same author last year. Faster RCNN is a popular target detection framework, and Mask RCNN extends it to be an instance segmentation framework. Mask RCNN is a new convolutional network based on Fast RCNN architecture, which completes the instance segmentation, and this method accomplishes a high-quality instance segmentation while effectively targeting at the same time. Mask RCNN algorithm mainly extends the original Faster-RCNN, adds a branch for predicting a target in parallel using the existing detection. At the same time, this network structure is relatively easy to implement and train, and can be easily applied to other fields, such as target detection, segmentation, and detection of character key points.

The technical solutions of the present disclosure will be described in detail below with specific embodiments. The following specific embodiments may be combined with each other, and the same or similar concepts or processes may not be elaborated in some embodiments.

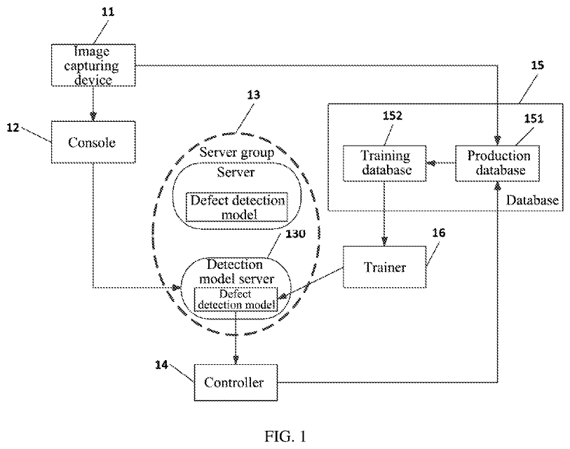

An application scenario to which the embodiments of the present disclosure are applicable is briefly described below. Referring to FIG. 1, which is a schematic structural diagram of a system for detecting a peripheral circuit of a display screen provided by an embodiment of the present disclosure. In the system shown in FIG. 1, the method for detecting a peripheral circuit of a display screen provided by the present disclosure is applied to perform defect detection on the peripheral circuit of the display screen. As shown in FIG. 1, the system for detecting a peripheral circuit of a display screen mainly includes: a console 12, a server group 13, a controller 14, a database 15, a trainer 16 and an image capturing device 11 deployed on a production line of the peripheral circuit of the display screen.

The image capturing device 11 captures a peripheral circuit image of the display screen on the production line of the peripheral circuit of the display screen. The console 12 receives the peripheral circuit image of the display screen captured by the image capturing device 11 and sends the peripheral circuit image of the display screen to a detection model server 130 in the server group 13. The detection model server 130 inputs the received peripheral circuit image of the display screen into a defect detection model that runs on it to obtain a defect detection result. The controller 14 receives the defect detection result of the detection model server 130 and combines production stage information to provide a business response. The controller 14 can also store the defect detection result as a log into the database 15. In addition, the peripheral circuit image of the display screen captured by the image capturing device 11 may also be directly stored into the database 15 as raw data for defect detection model training. The trainer 16 extracts a historical defective peripheral circuit image of the display screen from the database and obtains the defect detection model based on the Mask RCNN algorithm.

Optionally, the database 15 may include a production database 151 and a training database 152. The production database 151 may receive and save the defect detection result sent by the controller 14 and the peripheral circuit image of the display screen captured by the image capturing device 11. The training database 152 may store the historical defective peripheral circuit image of the display screen extracted from the production database 151 and a corresponding original peripheral circuit image of the display screen, so that the trainer 16 can perform training to obtain the defect detection model with high detection accuracy.

Optionally, the trainer 16 in the embodiment of the present disclosure may be a training engine implemented by hardware and/or software functions, serving as a training tool for the defect detection model. The system for detecting a peripheral circuit of a display screen according to the embodiment of the present disclosure may further include a processor, a memory and other physical modules, which is not limited in the embodiment.

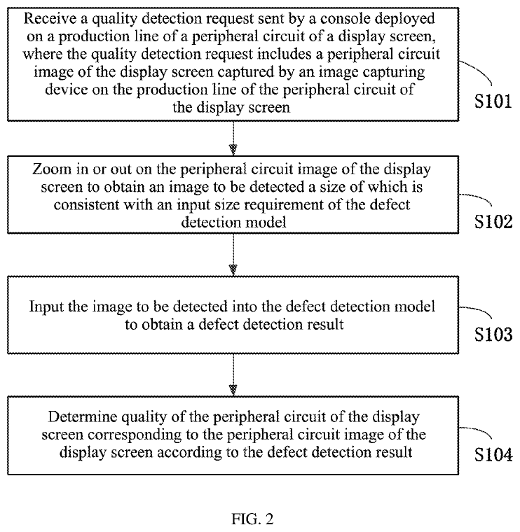

Refer to FIG. 2, which is a schematic flowchart of Embodiment 1 of a method for detecting a peripheral circuit of a display screen provided by an embodiment of the present disclosure. The execution body of the method shown in FIG. 2 may be a software device, a hardware device, or a device combing software and hardware. Steps S101 to S104 are included, which are specifically as follows:

S101, receive a quality detection request sent by a console deployed on a production line of the peripheral circuit of the display screen, where the quality detection request includes a peripheral circuit image of the display screen captured by an image capturing device on the production line of the peripheral circuit of the display screen.

Optionally, in the embodiment of the present disclosure, various different devices, such as the image capturing device, the console, a server group, a controller and a database, are deployed on the production line of the peripheral circuit of the display screen. The image capturing device can be a high-precision image capturing camera. In the process of producing the peripheral circuit of the display screen, multiple peripheral circuit images of the display screen corresponding to the peripheral circuit of the display screen that is in the production process can be captured by adjusting the angle, light, filter, zoom lens, focus and so forth of the image capturing device.

After the image capturing device on the production line of the peripheral circuit of the display screen captures the peripheral circuit image of the display screen, the console deployed on the production line of the peripheral circuit of the display screen may send the quality detection request to a server group, which is deployed with a defect detection model, on the production line of the peripheral circuit of the display screen, and the quality detection request includes the peripheral circuit image of the display screen captured by the image capturing device mentioned above, so that a server receiving the quality detecting request in the server group processes the received peripheral circuit image of the display screen.

S102, zoom in or out on the peripheral circuit image of the display screen to obtain an image to be detected a size of which is consistent with an input size requirement of a defect detection model.

S103, input the image to be detected into the defect detection model to obtain a defect detection result.

The defect detection model is obtained by performing training with a historical defective peripheral circuit image of the display screen using an instance segmentation Mask RCNN algorithm. The defect detection model obtained by training an instance segmentation Mask RCNN has a size requirement on the input image, once the size of the input image is not consistent with the size required by the model input, the defect detection model then cannot process it. When the peripheral circuit of the display screen is detected, a line direction and a shape of winding indicated by a global image are more likely to represent a possible defect problem. Therefore, before inputting the defect detection model in the present embodiment, the peripheral circuit pattern of the display screen is performed with a scaling processing firstly, so that the size of the image to be detected is consistent with the input size requirement of the defect detection model.

Zooming in or out on the peripheral circuit image of the display screen can be understood as zooming in or out with pixels being unchanged, or as zooming in or out with pixels being reduced. If there are too many pixels, the processing capability of the defect detection model may be exceeded. Therefore, in the case where the peripheral circuit image of the display screen has too many pixels, a pixel reduction processing can be performed on the peripheral circuit image of the display screen, which is not limited herein.

Optionally, the server that receives the quality detection request acquires the peripheral circuit image of the display screen in the quality detection request, and performs preprocessing of zooming in or out to obtain an image to be detected the size of which is consistent with the input size requirement of the defect detection model. Then, the image to be detected is inputted into the defect detection model running on the server, and the defect detection model performs the defect detection to obtain the defect detection result.

In an implementation, image preprocessing may be performed on the peripheral circuit image of the display screen before zooming in or out on the peripheral circuit image of the display screen, where the image preprocessing includes one or more of the following processing: trimming, cutting, or rotating. It can be understood that the image capturing device deployed on the production line of the peripheral circuit of the display screen is generally a high-precision camera. Therefore, the peripheral circuit image of the display screen captured by the image capturing device may be large in size, or has a large amount of pixels, or is not suitable in position and so on. Therefore, after receiving the peripheral circuit image of the display screen included in the quality detection request sent by the console, it is necessary to preprocess the peripheral circuit image of the display screen according to actual conditions. For example, if an edge area of the peripheral circuit image of the display screen is large, the peripheral circuit image of the display screen can then be trimmed, to retain a useful portion of the peripheral circuit image of the display screen.

It is worth noting that the defect detection model running on the server is obtained by performing training with the historical defective peripheral circuit image of the display screen using the instance segmentation Mask RCNN algorithm. Specifically, the Mask RCNN algorithm is used to perform instance segmentation in this embodiment. The instance segmentation refers to making the computer perform segmentation according to individual instances of the image, that is, distinguishing each defect and identifying the type of each defect. In the embodiment of the present disclosure, the defect detection model adopts a MASK RCNN structure. Specifically, the peripheral circuit image of the display screen on the production line of the peripheral circuit of the display screen is used as an input of the defect detection model, to identify the characteristics of each pixel in the peripheral circuit image of the display screen with the MASK RCNN structure of the defect detection model, that is, which pixel points in the image are normal pixel points, which pixel points are defective pixel points and which types of defect the defective pixel points are, are obtained.

As an example, a model training process may also be included before inputting the peripheral circuit image of the display screen into the defect detection model to obtain the defect detection result. Specifically, the training using the MASK RCNN algorithm may be performed on the defect detection model with an actual pixel type of the historical defective peripheral circuit image of the display screen, so that a loss value between a predicted pixel type that is outputted by the defect detection model for the historical defective peripheral circuit image of the display screen and an actual pixel type is lower than a preset loss threshold.

The loss value can be understood as a total loss value, and the defect detection model performs combined training with a candidate region loss value, a region type loss value, a region boundary loss value and a pixel instance loss value of the historical defective peripheral circuit image of the display screen, so that the total loss value of the candidate region loss value, the region type loss value, the region boundary loss value and the pixel instance loss value satisfies the preset loss threshold. The candidate region loss value refers to a loss value between a selected defect region and an actual defect region in the historical defective peripheral circuit image of the display screen, the region type loss value refers to a loss value between a predicted defect type and an actual defect type in the selected defective region, the region boundary loss value refers to a loss value between a predicted defect boundary and an actual defect boundary in the selected defect region, and the pixel instance loss value refers to a loss value between a predictive pixel instance and an actual pixel instance in the historical defective peripheral circuit image of the display screen.

The embodiment of the present disclosure can utilize the MASK RCNN model, which has high robustness for deformation, blur, illumination changes and other characteristics of the peripheral circuit image of the display screen captured by the image capturing device on the production line of the peripheral circuit of the display screen, and has a higher generalization for classification tasks.

It should be noted that, in the embodiment of the present disclosure, for different production scenarios and characteristics of peripheral circuit images of display screens, an organization manner of the MASK RCNN model that is required for training the defect detection model may be different, which may be determined according to actual conditions, and it is not limited in the present embodiment.

S104, determine quality of the peripheral circuit of the display screen corresponding to the peripheral circuit image of the display screen according to the defect detection result.

Optionally, in the embodiment of the present disclosure, after the defect detection result is obtained according to the defect detection model, the quality of the peripheral circuit of the display screen corresponding to the peripheral circuit image of the display screen may be determined according to the defect detection result.

Optionally, in an embodiment of the present disclosure, the defect detection result may include: a type of each defect, and/or a contour position of each defect. For example, when there is a defect in the peripheral circuit image of the display screen, the defect detection result that is obtained by the defect detection model may include defect type (all type of defect existing on the peripheral circuit of the display screen), defect position (specific pixel position of each defect) and defect contour (contour shape of each defect). The manner in which the defect detection result is presented can be understood as that the defect detection model outputs a segmentation image, where a normal pixel of the segmentation image is identified by a first color, a first defect is identified by a second color, and a second defect is identified by the third color. The first defect and the second defect can be the same type of defect, or can be different types of defects. In a defect detection result indicating two types of defects are detected, for example, it may be a segmentation image with a white background, a blue patch and a green patch, in which the white represents a pixel of a normal region, the blue represents a pixel of a point type defect region, and the green represents a pixel of another point type defect. The MASK RCNN model is to recognize pixel points, so various defect patterns can be obtained from the defect detection result, which can be understood as the contour shapes of various types of defects and the pixel positions of various types of defects in the peripheral circuit image of the display screen.

Correspondingly, S104 (determining quality of the peripheral circuit of the display screen corresponding to the peripheral circuit image of the display screen according to the defect detection result) may be replaced with: determining the quality of the peripheral circuit of the display screen corresponding to the peripheral circuit image of the display screen according to production stage information and the defect detection result.

Specifically, for various production stage information, such as manufacturer, production environment and the type of the peripheral circuit of the display screen, different defect detection results may be obtained in the process of detecting the peripheral circuit of the display screen. For different types of peripheral circuits of display screens, production stages are different. Therefore, when analyzing the defect detection result obtained above, the production stage information of each peripheral circuit of the display screen needs to be considered to determine the quality of the peripheral circuits of the display screen.

It should be noted that the defect detection model in the embodiment of the present disclosure can detect several types of defects in the peripheral circuit image of the display screen, and the specific number of defects of each type, that is, the defect detection model that is obtained by adopting the MASK RCNN algorithm can distinguish different defective individuals belonging to the same type.

The method for detecting a peripheral circuit of a display screen provided by the embodiment of the present disclosure receives the quality detection request sent by the console deployed on the production line of the peripheral circuit of the display screen, where the quality detection request includes the peripheral circuit image of the display screen captured by the image capturing device on the production line of the peripheral circuit of the display screen. The peripheral circuit image of the display screen is inputted into the defect detection model to obtain the defect detection result, and the quality of the peripheral circuit of the display screen corresponding to the peripheral circuit image of the display screen can be determined according to the defect detection result. Since the defect detection model is obtained by training with the historical defective peripheral circuit image of the display screen using the MASK RCNN algorithm, the defect detection result obtained by using the defect detection model thus has high classification precision, strong intelligence capability, improved system performance and high business expansion capability.

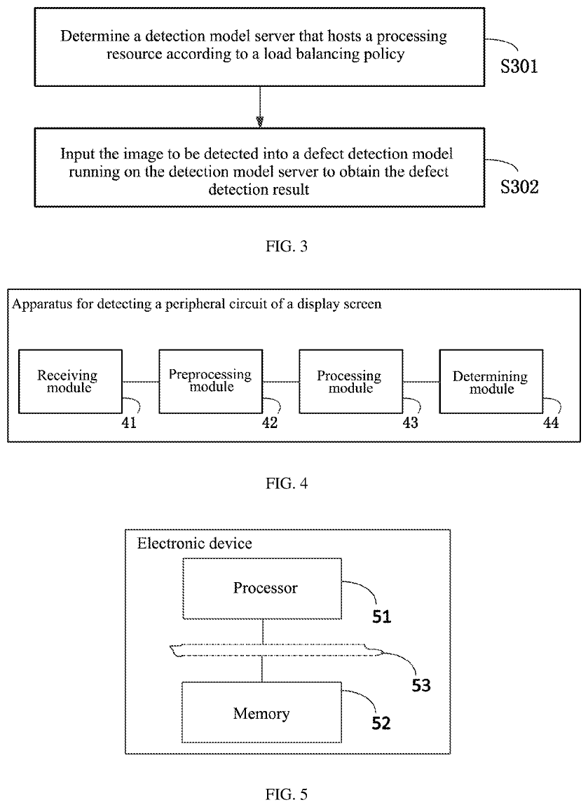

Refer to FIG. 3, which is a schematic flowchart diagram of Embodiment 2 of the method for detecting a peripheral circuit of a display screen provided by an embodiment of the present disclosure. On the basis of the foregoing embodiment, in the embodiment shown in FIG. 3, the above S104 (inputting the image to be detected into the defect detection model to obtain a defect detection result) can be implemented by steps S301-S302, which is specifically as follows:

S301, determine a detection model server that hosts a processing resource according to a load balancing policy.

Optionally, in the embodiment of the present disclosure, the server group is deployed on the production line of the peripheral circuit of the display screen, and there may be multiple servers in the server group, and each server runs a defect detection model. Optionally, the defect detection model running on each server is the same, so each server can receive the quality detection request sent by the console and then use the defect detection model hosted on itself to perform the quality detection on the peripheral circuit image of the display screen.

As an example, since the image capturing device deployed on the production line of the peripheral circuit of the display screen captures the peripheral circuit image of the display screen in real time, and therefore, the console may also send the quality detection request to any server in the server group in real time.

Optionally, since the defect detection model running on each server in the server group is the same, therefore in order to improve the detection efficiency of the defect detection model on the server and ensure the load balancing among the defect detection models, a server may be selected from the server group to be the detection module server that hosts the processing resource according to a preset load balancing policy, that is, load balancing and scheduling may be performed in real time according to the deployment situation of the defect detection models on the production line of the peripheral circuit of the display screen.

S302, input the image to be detected into the defect detection model running on the detection model server to obtain the defect detection result.

Optionally, in the embodiment of the present disclosure, after determining the detection model server that hosts the processing resource from the server group, the peripheral circuit image of the display screen above may be inputted into the defect detection model running on the detection model server, to use the defect detection model to detect a defect in the peripheral circuit image of the display screen and then obtain the defect detection result. Optionally, the defect detection model is obtained by the training module training with the preset pixel type and the actual pixel type in the historical defective peripheral circuit image of the display screen.

The method for detecting a peripheral circuit of a display screen provided by the embodiment of the present disclosure determines the detection model server that hosts the processing resource according to the load balancing policy, and inputs the image to be detected to the defect detection model running on the detection model server to obtain the defect detection result, which can achieve load balancing among servers, improve the efficiency of detecting the peripheral circuit image of the display screen, and improve the performance of the system for detecting the peripheral circuit detection of the display screen.

In an implementation, after the step S302 (inputting the image to be detected into the defect detection model running on the detection model server to obtain the defect detection result), the method may further include the following steps:
if it is determined that the peripheral circuit of the display screen is a damaged circuit, performing one or more of the following operations:
sending alarm information to a production manager through a controller;
storing the defect detection result as a log into a production database through the controller;
sending a production control instruction to the console through the controller to eliminate a defect;
inputting the peripheral circuit image of the display screen and the defect detection result into the defect detection model to optimize the defect detection model.

Optionally, in the embodiment of the present disclosure, testing personals may preset a solution that is performed when it is determined, according to the production scenario and the production stage information of the peripheral circuit of the display screen, that the peripheral circuit of the display screen is a bad screen, for example, sending the alarm information through the controller, and/or storing the defect detection result as a log into the production database through the controller, and/or sending the production control instruction to the console through the controller to eliminate the defect, and/or inputting the peripheral circuit image of the display screen and the defect detection result into the defect detection model to optimize the defect detection model and so on.

Specifically, as an example, when it is determined, according to the defect detection result, that the peripheral circuit of the display screen corresponding to the peripheral circuit image of the display screen is a damaged circuit, that is, there is a defect in the peripheral circuit of the display screen, an alarm message may be sent, so that the production manager can locate the type and position of the defect in time and provide a solution.

As another example, when it is determined that there is a defect in the peripheral circuit of the display screen according to the defect detection result, the defect detection result may be stored as a log into the production database through the controller, that is, the type of each defect of the display peripheral circuit and/or the contour position of each defect is stored as a log into the production database, which can be filtered into the training database, and the defect detection model can be upgraded by the training module (which may be a software program such as a training engine) according to the defective peripheral circuit image of the display screen.

As still another example, when it is determined that there is a defect in the peripheral circuit of the display screen according to the defect detection result above, a production control instruction may also be sent to the console through the controller to eliminate a defect. That is, the detection model server hosting the defect detection model can determine the cause of the defect through the controller, and then adjust the production process accordingly, that is, the detection model server sends the production control instruction to the console through the controller to eliminate the defect appearing on the periphery circuit of the display screen and to reduce the probability of the damaged circuit.

As still another example, when it is determined that there is a defect in the peripheral circuit of the display screen according to the defect detection result above, the peripheral circuit image of the display screen and the defect detection result may be directly inputted into the defect detection model to optimize the defect detection model. That is, the peripheral circuit image of the display screen corresponding to the damaged circuit is directly used as a training set of the defect detection model to optimize the defect detection model, thereby improving the detection accuracy of the defect detection model.

It should be noted that, the embodiment of the present disclosure is not limited to the above-mentioned one or more operations performed by the detection module server when it is determined that the peripheral circuit of the display screen is a damaged circuit, which may be determined according to actual conditions and are not elaborated herein.

Optionally, for a plurality of different devices, such as the image capturing device, the console, the server group, the controller, the database and the like deployed on the production line of the peripheral circuit of the display screen, the operation steps corresponding to the method for detecting a peripheral circuit of a display screen may also be distributed to the above various different devices to execute. For example, the image capturing device captures the peripheral circuit image of the display screen, the console sends the peripheral circuit image of the display screen captured by the image capturing device to the detection model server in the server group according to the load balancing policy, and the defect detection model running on the detection model server performs preset preprocessing on the peripheral circuit image of the display screen, then performs defect detection and provides the defect detection result. The detection model server can send the defect detection result to the controller. On the one hand, the controller generates a response, such as alarming, storing a log, controlling a production control instruction or the like, which is in conformity with the actual business scenario requirement, according to the business requirement and the defect detection result in combination with the actual business scenario; on the other hand, the controller may also store the defect detection result and the above processing behavior of the response as a log into the production database, so that the training module updates the obtained defect detection model according to the peripheral circuit image of the display screen and the defect detection result in the training database, where the training database stores data, such as the peripheral circuit image of the defective display screen and a corresponding defect detection result, filtered from the production database.

It is worth noting that each optimized defect detection model may gradually replace the defect detection model running on the server by a small flow online manner to achieve a purpose of dynamically expanding the defect detection model along with the business scenario and the production stage information. When the method for detecting a peripheral circuit of a display screen according to the embodiment of the present disclosure has run for a period of time on the production line of the peripheral circuit of the display screen, the accuracy of the defect detection and defect localization may be reviewed manually through the information in the production database, and then the training database may be updated, and the defect detection model may be retrained to improve the defect detection accuracy.

The following is an embodiment of the apparatus according to the present disclosure, which may be used to implement the method embodiments of the present disclosure. For details not disclosed in the apparatus embodiment of the present disclosure, refer to the method embodiments of the present disclosure.

Refer to FIG. 4, which is a schematic structural diagram of an embodiment of an apparatus for detecting a peripheral circuit of a display screen provided by an embodiment of the present disclosure. As shown in FIG. 4, the apparatus for detecting a peripheral circuit of a display screen provided by the embodiment of the present disclosure may mainly include: a receiving module 41, a preprocessing module 42, a processing module 43, and a determining module 44.

The receiving module 41 is configured to receive a quality detection request sent by a console deployed on a production line of the peripheral circuit of the display screen, where the quality detection request includes a periphery circuit image of the display screen captured by an image capturing device on the production line of the peripheral circuit of the display screen.

The pre-processing module 42 is configured to zoom in or out on the peripheral circuit image of the display screen to obtain an image to be detected a size of which is consistent with an input size requirement of a defect detection model, where the defect detection model is obtained by training with a historical defective peripheral circuit image of the display screen using an instance segmentation MASK RCNN algorithm.

The processing module 43 is configured to input the image to be detected into the defect detection model to obtain a defect detection result.

The determining module 44 is configured to determine quality of the peripheral circuit of the display screen corresponding to the peripheral circuit image of the display screen according to the defect detection result.

The apparatus for detecting a peripheral circuit of a display screen according to the embodiment shown in FIG. 4 can be used to perform the steps in the method embodiment shown in FIG. 2, and the implementation principle and technical effects are similar, which are not elaborated herein again.

Optionally, the processing module 43 is further configured to perform training on the defect detection model with an actual pixel type of the historical defective peripheral circuit image of the display screen using the MASK RCNN algorithm before inputting the peripheral circuit image of the display screen into the defect detection model to obtain the defect detection result, so that a loss value between a predicted pixel type that is outputted by the defect detection model for the historical defective peripheral circuit image of the display screen and the actual pixel type is lower than a preset loss threshold.

Optionally, the pre-processing module 42 is further configured to perform image preprocessing on the peripheral circuit image of the display screen before zooming in or out on the peripheral circuit image of the display screen, where the image preprocessing includes one or more of the following processes: trimming, shearing, or rotating.

Optionally, the processing module 43 is specifically configured to determine the detection model server that hosts a processing resource according to a load balancing policy, and input the image to be detected into the defect detection model running on the detection model server to obtain the defect detection result.

Optionally, the defect detection result includes: a type of each defect, and/or a contour position of each defect.

The determining module 44 is specifically configured to determine the quality of the peripheral circuit of the display screen corresponding to the peripheral circuit image of the display screen according to production stage information and the defect detection result.

Optionally, the processing module 43 is further configured to perform one or more of the following operations if the peripheral circuit of the display screen is determined to be a damaged circuit, after the quality of the peripheral circuit of the display screen corresponding to the peripheral circuit image of the display screen is determined according to the defect detection result,
sending alarm information to a production manager through a controller;
storing the defect detection result as a log into a production database through the controller;
sending a production control instruction to a console through the controller to eliminate a defect;
inputting the peripheral circuit image of the display screen and the defect detection into the defect detection model to optimize the defect detection model.

The apparatus for detecting a peripheral circuit of a display screen according to the above apparatus embodiment can be used to implement the implementation of the method embodiments shown in FIG. 2 and FIG. 3, and the specific implementation and technical effects are similar, and are not elaborated herein again.

Refer to FIG. 5, which is a schematic structural diagram of an embodiment of an electronic device provided by an embodiment of the present disclosure. The electronic device includes: a processor 51, a memory 52 and a computer program.

The memory 52 is configured to store the computer program, and the memory may also be a flash. The computer program is, for example, an disclosure, a function module, or the like that implements the above methods.

The processor 51 is configured to execute the computer program stored in the memory to implement various steps executed by the electronic device in the above methods. Specifically, the related description in the foregoing method embodiments can be referred to.

Optionally, the memory 52 can be either independent of or integrated with the processor 51.

When the memory 52 is a device independent of the processor 51, the electronic device may further include:
a bus 53, configured to connect the memory 52 and the processor 51.

The present disclosure also provides a storage medium storing instructions, which when running on a computer, cause the computer to perform the method of the method embodiments shown in FIG. 2 and FIG. 3.

The storage medium may be a computer storage medium or a communication medium. The communication medium includes any medium that facilitates transmission of a computer program from one location to another. The computer storage medium can be any medium that a general purpose or special purpose computer can access. For example, a storage medium is coupled to the processor, such that the processor can read information from the readable storage medium and can write information to the storage medium. Of course, the storage medium can also be an integral part of the processor. The processor and the storage medium may be located in an Application Specific Integrated Circuits (ASIC). Additionally, the ASIC can be located in a user equipment. Of course, the processor and the storage medium may also exist as discrete components in a communication device.

The disclosure also provides a program product, which includes a computer program, and the computer program is stored in the storage medium. At least one processor of the apparatus for detecting a peripheral circuit of a display screen can read the computer program from the storage medium, and the at least one processor executes the computer program to implement the method executed by the apparatus for detecting a peripheral circuit of a display screen shown in FIG. 2 and FIG. 3.

In the above embodiment of the electronic device, it should be understood that the processor may be a Central Processing Unit (CPU), or other general-purpose processors, a Digital Signal Processor (DSP), an Application Specific Integrated Circuit (ASIC) and so on. The general-purpose processor may be a microprocessor or the processor may also be any conventional processor or the like. The steps of the method disclosed in connection with the present disclosure may be directly embodied as being implemented by a hardware processor or by a combination of hardware and software modules in the processor.

Finally, it should be noted that the above embodiments are merely illustrative of the technical solutions of the present disclosure, and are not intended to be limiting; although the present disclosure has been described in detail with reference to the foregoing embodiments, those skilled in the art will understand that the technical solutions described in the foregoing embodiments may be modified, or some or all of the technical features may be equivalently replaced; and the modifications or substitutions will not make the corresponding technical solution to deviate from the scope of technical solutions of the embodiments of the present disclosure.

What is claimed is:

1. A method for detecting a peripheral circuit of a display screen, comprising:
receiving a quality detection request sent by a console deployed on a production line of the peripheral circuit of the display screen, wherein the quality detection request comprises a peripheral circuit image of the display screen captured by an image capturing device on the production line of the peripheral circuit of the display screen;
zooming in or out on the peripheral circuit image of the display screen to obtain an image to be detected a size of which is consistent with an input size requirement of a defect detection model, wherein the defect detection model is obtained by training with a historical defective peripheral circuit image of the display screen using an instance segmentation Mask Regional Convolutional Neural Network (RCNN) algorithm;
inputting the image to be detected into the defect detection model to obtain a defect detection result; and
determining quality of the peripheral circuit of the display screen corresponding to the peripheral circuit image of the display screen according to the defect detection result.

2. The method according to claim 1, wherein before the inputting the peripheral circuit image of the display screen into the defect detection model to obtain a defect detection result, the method further comprises:
performing training on the defect detection model with an actual pixel type of the historical defective peripheral circuit image of the display screen using the instance segmentation Mask RCNN algorithm, so that a loss value between a predicted pixel type that is outputted by the defect detection model for the historical defective peripheral circuit image of the display screen and the actual pixel type is lower than a preset loss threshold.

3. The method according to claim 1, wherein before the zooming in or out on the peripheral circuit image of the display screen, the method further comprises:
performing image preprocessing on the peripheral circuit image of the display screen, wherein the image preprocessing includes one or more of the following processes:
trimming, cutting, or rotating.

4. The method according to claim 1, wherein the inputting the image to be detected into the defect detection model to obtain a defect detection result, comprises:
determining a detection model server that hosts a processing resource according to a load balancing policy; and
inputting the image to be detected into the defect detection model that runs on the detection model server to obtain the defect detection result.

5. The method according to claim 1, wherein the defect detection result comprises: a type of each defect, and/or a contour position of each defect; and
the determining quality of the peripheral circuit of the display screen corresponding to the peripheral circuit image of the display screen according to the defect detection result, comprises:
determining the quality of the peripheral circuit of the display screen corresponding to the peripheral circuit image of the display screen according to production stage information and the defect detection result.

6. The method according to claim 1, wherein after the determining quality of the peripheral circuit of the display screen corresponding to the peripheral circuit image of the display screen according to the defect detection result, the method further comprises:
if it is determined that the peripheral circuit of the display screen is a damaged circuit, performing one or more of the following operations:
sending alarm information to a production manager through a controller;
storing the defect detection result as a log into a production database through the controller;
sending a production control instruction to the console through the controller to eliminate a defect; and
inputting the peripheral circuit image of the display screen and the defect detection result to the defect detection model to optimize the defect detection model.

7. An apparatus for detecting a peripheral circuit of a display screen, comprising:
a processor, a memory, and a computer program that is stored on the memory and executable on the processor;
wherein when the computer program is executed by the processor, the computer program causes the processor to: receive a quality detection request sent by a console deployed on a production line of the peripheral circuit of the display screen, wherein the quality detection request includes a peripheral circuit image of the display screen captured by an image capturing device on the production line of the peripheral circuit of the display screen;
zoom in or out on the peripheral circuit image of the display screen to obtain an image to be detected a size of which is consistent with an input size requirement of a defect detection model, wherein the defect detection model is obtained by training with a historical defective peripheral circuit image of the display screen using an instance segmentation Mask Regional Convolutional Neural Network (RCNN) algorithm;
input the image to be detected into the defect detection model to obtain a defect detection result; and
determine quality of the peripheral circuit of the display screen corresponding to the peripheral circuit image of the display screen according to the defect detection result.

8. The apparatus according to claim 7, wherein the computer program further causes the processor to train on the defect detection model with an actual pixel type of the historical defective peripheral circuit image of the display screen using the instance segmentation Mask RCNN algorithm before inputting the image to be detected into the defect detection model to obtain the defect detection result, so that a loss value between a predicted pixel type that is outputted by the defect detection model for the historical defective peripheral circuit image of the display screen and the actual pixel type is lower than a preset loss threshold.

9. The apparatus according to claim 7, wherein the computer program further causes the processor to perform image preprocessing on the peripheral circuit image of the display screen before zooming in or out on the peripheral circuit image of the display screen, wherein the image preprocessing comprises one or more of the following processes: trimming, cutting, or rotating.

10. The apparatus according to claims 7, wherein,
the computer program further causes the processor to determine a detection model server that hosts a processing resource according to a load balancing policy;
and input the image to be detected into the defect detection model that runs on the defect detection server to obtain the defect detection result.

11. The apparatus according to claim 7, wherein the defect detection result comprises: a type of each defect, and/or a contour position of each defect; and
the computer program further causes the processor to determine the quality of the peripheral circuit of the display screen corresponding to the peripheral circuit image of the display screen according to production stage information and the defect detection result.

12. The apparatus according to claim 7, wherein the computer program further causes the processor to operate the following operations if it is determined that the peripheral circuit of the display screen is a damaged circuit, after the determining the quality of the peripheral circuit of the display screen corresponding to the peripheral circuit image of the display screen according to the defect detection result,
send alarm information to a production manager through a controller;
restore the defect detection result as a log into a production database through the controller;
send a production control instruction to a console through the controller to eliminate a defect; and
input the peripheral circuit image of the display screen and the defect detection result to the defect detection model to optimize the defect detection model.

13. A non-volatile storage medium, wherein the storage medium stores instructions, which when running on a computer, cause the computer to perform the method according to claim 1.
